(19) United States
(12) Patent Application Publication
(10) Pub. No.: US 2013/0328295 A1
(43) Pub. Date: Dec. 12, 2013

(54) STABILIZER DEVICE FOR AN OPERATING MACHINE

(71) Applicant: Gianni Borghi, Modena (IT)

(72) Inventor: Gianni Borghi, Modena (IT)

(73) Assignee: C.M.C.S.R.l Societa Unipersonale, Casterfranco Emillia Modena (IT)

(21) Appl. No.: 13/977,866

(22) PCT Filed: Jan. 13, 2012
(86) PCT No.: PCT/IB12/00043

§ 371 Date: Aug. 30, 2013

(30) Foreign Application Priority Data
Jan. 17, 2011 (IT) M02011A00005

(51) Int. Cl. B66C 5/00

(52) U.S. Cl. CPC B66C 5/00
USPC 280/765.1

(57) ABSTRACT

Stabilizer device for an operating machine, having a chassis with a pair of stabilizer means associated to one of two opposite ends thereof. They include two stabilizer arms constrained to be symmetric with respect to a vertical middle plane and equipped with feet for resting on the ground. Each stabilizer arm includes a first, straight segment bound with one first end to the chassis and one second segment hinged to the second end of the first segment. The first and second segments are aimed at being mutually positioned in a retracted position (R) in which the encumbrance of said stabilizer arm remains within the operating machine maximum size limits, and an extended, in-operation position (L), in which the related resting foot is in contact with the ground. The axes of both first segments of said pair are included in the same plane, that is perpendicular to the middle plane.

### DESCRIPTION OF THE INVENTION

The invention relates to a stabilizer device for an operating machine.

In particular, but not exclusively, the invention can be advantageously used in road or on-site operating machines, like for example, lifting mechanisms, cranes, lifting platforms, etc.

These types of machines are usually self-propelled and consequently, they must have prefixed maximum limits of the overall size when they travel on the road.

On the other hand, in the working configuration, the same machines must have a suitable stability configuration that allows them to work in full safety to lift and in general to move loads. For this reason, they are provided with stabilizer members or means, which are put in position when operated to assume the working configuration, in correspondence to which they extend well beyond the machine profile, i.e. the prefixed maximum limits of the overall size, occupying a substantial space all around it. This is the case of the stabilizer means, which, when the machine is stationary, are unfolded like “legs” which are equipped with suitable feet for resting on the ground. The machine is normally supported on these feet. Obviously, in order to obtain the maximum stability, one tries to make the perimeter that contains the resting area as big as possible or anyway, such that facilitates stability as much as possible. This means, in most applications, to put the resting feet at the largest possible mutual distance and consequently to provide removable “legs”, of telescopic type, or folding, for example of hinged type.

Anyhow, in all cases, it is necessary to take into consideration the dimensions imposed by the maximum size limits allowed for on-road travelling. Among the various solutions proposed by the prior art there is one worth remembering, the arrangement of stabilizers constituted by extendable “legs”, formed substantially by pairs of telescopic, extendable beams, arranged in cross fashion and fixed on the fore side of the machine chassis as well as on its rear side. These are real box-like beams provided with hydraulically powered extension, that are fixed so as to be crossed and superimposed in order to have extension length as long as possible. Since the beams transversal dimensions are not negligible at all, due to strength and rigidity, this overlaying, that occurs both at the front and at the back, produces an undesirable drawback of a “clear” increase of the overall length of the chassis and machine, equal to the double dimension of one of the mentioned beams. A drawback that, ultimately, results in a series of functional limitations of the machine.

The present invention, as it is defined by the claims and the present description, is substantially focused on the solution of the limits and drawbacks of the illustrated prior art.

The main advantages of the invention with respect to the prior art can be found in a greater compactness of the stabilizer devices and in a better and more effective arrangement of the various parts forming them.

Further characteristics will result more evident from the following description of a preferred, but not exclusive embodiment, illustrated by way of example, not limiting, in the enclosed drawings, in which:

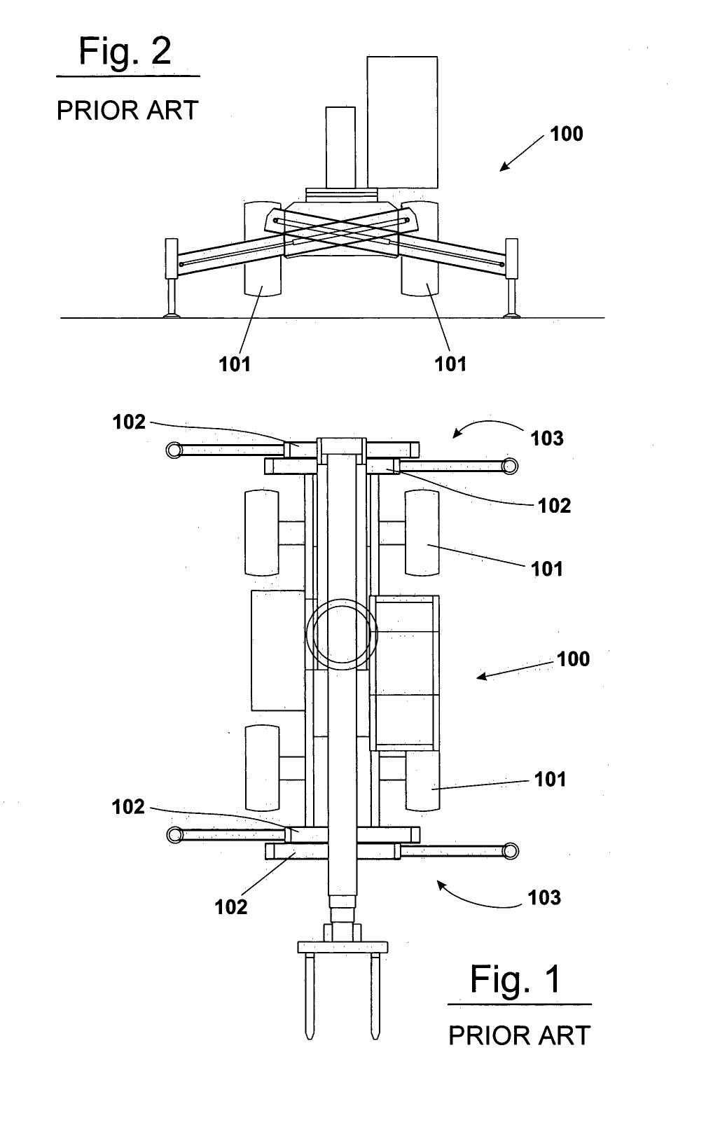

FIG. 1 is a schematic plan view of an example of prior art;

FIG. 2 is a front view of FIG. 1 with some parts partially sectioned and some omitted so as to better point out others;

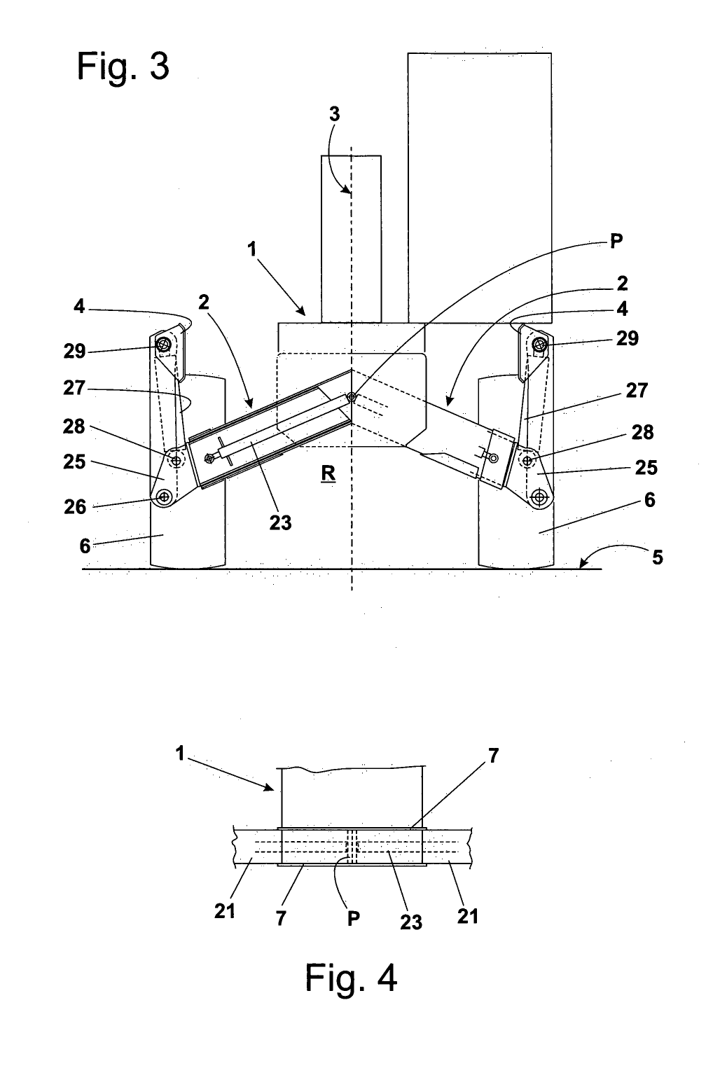

FIG. 3 is a schematic front, partially sectioned view of the embodiment of the invention in the retracted configuration of minimum extension;

FIG. 4 is a part of a schematic top view of FIG. 3;

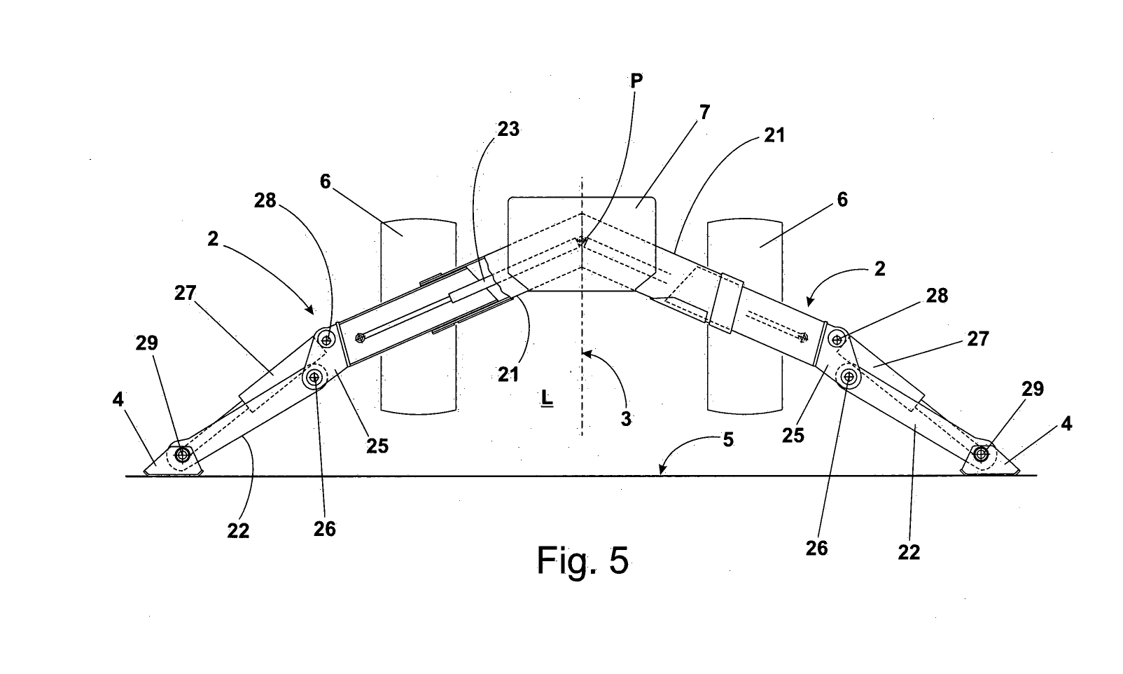

FIG. 5 is the same front view of FIG. 3 in the maximum extension, in-operation configuration.

The enclosed Figures include also some schematic illustrations that show stabilizer devices being a part of the prior art, applied to an operating machine 100, which is self-moving and thus provided with wheels 101.

Such machine is provided, at the front and at the back, with stabilizer members or means which are used when they are moved to in-operation configuration, in correspondence to which they extend well beyond the machine profile, i.e. beyond the prefixed maximum limits of the overall size for the on-road travelling, occupying a considerable space outside the machine. These are stabilizer means 103 which, when the machine is stationary, are unfolded like “legs” which are equipped with feet for resting on the ground, so as to allow taking a suitable stability configuration, which allows the machine to work in full safety to lift and in general to move loads. Obviously, in order to obtain the maximum stability, one tries, by resting the feet on the ground, to make the perimeter that contains the resting area as large as possible or anyway, such that facilitates stability as much as possible. This means to put the resting feet at the biggest possible mutual distance.

In the illustrated example of the prior art, the stabilizer members 103 are constituted by telescopic type extendable “legs” 102, which, when in the retracted position, must be in the minimum extension configuration, so as to allow the machine to stay within the admitted (transversal) profile, while in the in-operation position, they must take their maximum possible extension configuration.

In order to obtain, with a retracted position requested by the respect of the machine admitted profile, with the configuration as extended as possible, the telescopic type extendable “legs” 102 are formed by pairs of real extendable telescopic beams, which, just in order to exploit the maximum length of the segments of the telescopic structure, are arranged characteristically one close to another so as not to interfere one with another, and thus possibly to be arranged to form an overlaying cross at the fore side of the machine chassis as well as at the rear side thereof.

It is to be noted that these are real box-like beams, provided with hydraulic extension, whose transversal dimensions are not negligible at all, due to strength and rigidity reasons.

Besides an asymmetry problem, this results in a consequent longitudinal encumbrance, equal to the sum of the transversal dimensions of the two beams.

The embodiment of the invention shows a self-moving operating machine having wheels 6, which is provided with a stabilizer device, firmly associated to the chassis 1 of the operating machine.

A pair of stabilizer members is associated to each of the two opposite ends of the chassis 1 (only to one end, in other, not illustrated embodiments).

Each single pair includes two stabilizer arms 2 constrained to be symmetric with respect to a vertical middle plane 3, and equipped with feet 4 for resting on the ground 5.

Each stabilizer arm 2, in turn, includes a first straight segment 21, bound with one first end to the chassis 1, and at least one second segment 22 hinged to the second end 25 of the first segment 21.

The first segments 21 of each pair of stabilizer arms 2 are fixed integrally to the fore and rear ends of the chassis 1 by means of solid plates 7.

The first segment 21 and the second segment 22 of each pair of stabilizer arms 2 are aimed at being mutually positioned in a retracted position R, in which the encumbrance of the stabilizer arm 2 is within the maximum size limits admitted to the operating machine, and an extended, in-operation position L, in which the related resting foot 4 is in contact with the ground 5.

The axes of both the first segments 21 of each pair of stabilizer arms 2 present the peculiarity of being contained in the same plane, which is perpendicular to the middle plane 3. The latter normally coincides with the longitudinal middle plane of the operating machine.

The axes of both the first segments 21 of each pair of stabilizer arms 2 are convergent to a point P lying on the middle plane 3.

Furthermore, the first segments 21 are arranged symmetrical with respect to the middle plane 3.

The second end 25 of the first segment 21 of each said stabilizer arm 2 is driven to move by shifting along the axis of the related first segment 21 from a retracted, minimum extension position, to an outer, maximum extension position, by means of a linear actuator 23, which, in this case, is constituted by a hydraulic cylinder.

The second segment 22 is operated into rotation, in response to control commands, about a gudgeon 26, integral with the second end 25, by means of a linear actuator 27, also in this case constituted by a hydraulic cylinder. The linear actuator 27 is hinged to the second end 25 by means of a gudgeon 28. The other end of the linear actuator 27 is bound to the “free” end of the second segment 22, in correspondence to the gudgeon 29, to which the foot 4 is coupled.

The linear actuators 23 of each first segment 21 of the single stabilizer arm 2 of each pair are co-aligned with the axes of the related first segments 21 and have respective ends hinged about the same axis lying in said middle plane 3.

The stabilizer arms 2, of the pair situated at the front as well as of the pair situated at the back, carry out their function when they are moved to the in-operation configuration L, in which they extend well beyond the machine profile, i.e. beyond the prefixed maximum limits of the overall size admitted for on-road travelling, occupying a considerable space outside the machine.

The stabilizer arms are operated when the machine is stationary: they are operated by performing a kind of “opening” or unfolding from the retracted position R, in which both the linear actuator 23 and the linear actuator 27 are in the minimum extension configuration, until they reach the in-operation position L, in which both the linear actuator 23 and the linear actuator 27 are in the maximum extension configuration.

Reversal passage from the working position L to the retracted, or folded position R is obtained by reversing the movement directions.

The invention presents, among others, the advantage of realizing a considerable and large distance between the supports on the ground of the stabilizer arms of each pair (fore and/or rear).

1. A stabilizer device for an operating machine, having a chassis with a pair of stabilizer means associated to at least one of two opposite ends of it; said single pair including two stabilizer arms constrained to be symmetric with respect to a vertical middle plane and equipped with feet for resting on the ground; each said stabilizer arm including a first, straight segment bound with one first end to said chassis and at least one second segment hinged to the second end of said first segment; said first and second segments being designed to be mutually positioned in a retracted position (R) in which the encumbrance of said stabilizer arm remains within the operating machine maximum size limits, and an extended, in-operation position (L), in which the related resting foot is in contact with the ground; the axes of both first segments of said pair being included in the same plane, that is perpendicular to said middle plane; the axes of both first segments of said pair being convergent to a point (P) lying on said middle plane; and arranged symmetrically with respect to said middle plane; said second end of said first segment of each said stabilizer arm being driven to move by shifting along the axis of the related said first segment from a retracted, minimum extension position, to an outer, maximum extension position, by means of a linear actuator; characterized in that the second segment is driven so as to rotate, in response to control commands, about a gudgeon, integral with the second end by means of a linear actuator or a hydraulic cylinder; a first end of the linear actuator or hydraulic cylinder being hinged to the second end by means of a gudgeon; a second end of said linear actuator or hydraulic cylinder being bound to the “free” end of the second segment in correspondence to the gudgeon, to which the foot is coupled to said “free” end of the second segment.

2. A device, as claimed in claim 1, characterized in that said linear actuators of each first segment of the single stabilizer arm of each pair are co-aligned with the axes of the related first segments and have respective ends hinged about the same axis lying in said middle plane.

3. A device according to claim 2, characterized in that a pair of said stabilizer arms is associated to two opposite ends of said chassis.

4. A device according to claim 3, characterized in that said two opposite ends are respectively the front one and the rear one of the chassis of a mobile operating machine.
